(19) United States
(12) Patent Application Publication
(10) Pub. No.: US 2019/0061055 A1
(43) Pub. Date: Feb. 28, 2019

(54) METHOD FOR LASER WELDING OF CURVED SURFACES

(71) Applicant: GM GLOBAL TECHNOLOGY OPERATIONS LLC, Detroit, MI (US)

(72) Inventors: David Yang, Shanghai (CN); Wu Tao, Tianmen (CN); Blair Carlson, Ann Arbor, MI (US)

(21) Appl. No.: 15/684,398

(22) Filed: Aug. 23, 2017

(51) Int. Cl. B23K 26/244; B23K 26/046; B23K 26/082; B23K 26/322

(52) U.S. Cl. CPC B23K 26/244; B23K 26/046; B23K 2203/04; B23K 26/322; B23K 26/082

(57) ABSTRACT

A method of laser welding together two or more overlapping metal workpieces (12, 14 or 12, 504, 14) that define a welding region (16) in which at least a portion of an accessible top surface (20, 120, 220, 520) of a workpiece stack-up (10, 110, 210, 510) is curved or angled includes advancing a laser beam (24) along a beam travel pattern (74) that at least partially lies on the portion of the top surface that is curved or angled while maintaining a constant focal distance (64) of the laser beam during such advancing travel. The beam travel pattern may be projected onto a curved portion (20″, 220″) of the top surface, an angled portion (120″) of the top surface, or two or more portions (20′, 20″, 120′, 120″, 220′, 220″, 220′″) of the top surface that lack planarity.

### TECHNICAL FIELD

The technical field of this disclosure relates generally to laser welding a workpiece stack-up of overlapping metal workpieces and, more specifically, to a method of laser welding in which a laser beam is advanced along a curved or angled portion of an accessible top surface of the workpiece stack-up as well as along multiple portions of the accessible top surface that do not share a common plane.

### INTRODUCTION

Laser welding is a metal joining process in which a laser beam is directed at an assembly of stacked-up metal workpieces to provide a concentrated source of radiant energy capable of effectuating a weld joint between the constituent metal workpieces. In general, complimentary flanges or other bonding regions of two or more metal workpieces are first aligned, fitted, and stacked relative to one another such that their faying surfaces overlap and confront to establish one or more faying interfaces. A laser beam is then directed at an accessible top surface of the workpiece stack-up within a welding region spanned by the overlapping portion of the workpieces. The heat generated from the absorption of energy from the laser beam initiates melting of the metal workpieces and establishes a molten metal weld pool within the workpiece stack-up. And, if the power density of the laser beam is high enough, a keyhole is produced beneath a beam spot of the laser beam within the molten metal weld pool. A keyhole is a column of vaporized metal, which may include plasma, derived from the metal workpieces. The keyhole is an effective absorber of energy from the laser beam, thus allowing for deep and narrow penetration of molten workpiece metal into the stack-up.

The molten metal weld pool and, if present, the keyhole, are created in very short order once the laser beam impinges the top surface of the workpiece stack-up. After the metal workpieces are initially melted, the beam spot of the laser beam may be advanced relative to the top surface of the workpiece stack-up, which typically involves moving the laser beam along a beam travel pattern of a relatively simple or complex geometrical profile as projected onto the top surface of the stack-up. As the laser beam is advanced along the top surface of the stack-up, molten workpiece metal from the molten metal weld pool flows around and behind the advancing beam spot within the workpiece stack-up. This penetrating molten workpiece metal eventually cools and solidifies in the wake of the advancing laser beam into consolidated resolidified metal workpiece material. The transmission of the laser beam at the top surface of the workpiece stack-up is eventually ceased once the laser beam has finished tracking the beam travel pattern, at which time the keyhole collapses, if present, and any molten workpiece metal still remaining within the stack-up solidifies. The consolidated resolidified workpiece material obtained by operation of the laser beam constitutes a laser weld joint that autogenously fusion welds the overlapping metal workpieces together.

Many industries use laser welding as part of their manufacturing practice including the automotive, aviation, maritime, railway, and building construction industries, among others. Laser welding is an attractive joining process because it requires only single side access, can be practiced with reduced flange widths, and results in a relatively small heat-affected zone within the stack-up assembly that minimizes thermal distortion in the metal workpieces. In the automotive industry, for example, laser welding can be used to join together metal workpieces during the manufacture of the body-in-white (BIW) as well as finished hang-on parts that are installed on the BIW prior to painting. Some specific instances where laser welding may be used include the construction and attachment of load-bearing body structures within the BIW such as rail structures, rockers, A-, B-, and C-pillars, and underbody cross-members. Other specific instances where laser welding may also be used include non-load-bearing attachments within the BIW, such as the attachment of a roof to a side panel, and to join overlying flanges encountered in the construction of the doors, hood, and trunk.

The workpiece stack-ups that are laser welded during the manufacture of an automobile—as well as during the manufacture of other articles—may include prefabricated metal workpieces that provide the stack-up with a three-dimensional shape. The workpiece stack-up may thus have a variable surface contour. In some instances, when forming the laser weld joint, it may be desirable to advance the laser beam along curved or angled portions of the accessible top surface including, for example, advancing the laser beam along multiple portions of the top surface that do not share a common plane. Advancing the laser beam along these portions of the top surface may be a coveted proposition because any one of those portions may represent a location on the stack-up that has strategic significance in terms of joint strength, aesthetics, accessibility, and/or process efficiency. However, when the laser beam is advanced along portions of the top surface that have complex surface contours, the laser beam may become excessively focused or defocused due to a deviation in the focal distance of the laser beam. Such focusing and/or defocusing of the laser beam can, in turn, alter the heat input into the workpiece stack-up and cause too much or too little melting of the workpieces stack-up, thereby leading to inconsistent weld quality.

Because of the challenges associated with advancing the laser beam along curved or angled portions of the top accessible surface, particularly along two or more portions of the top surface that deviate out of plane, laser welding has typically been avoided in those regions of the workpiece stack-up. The confinement of laser welding to other regions of the top surface with less complex surface contours can, in some instances, render the overall welding process more difficult and/or less efficient in a manufacturing setting than it would otherwise be in the absence of such restrictions. Laser welding may even be overlooked in favor of other joining processes when the manufacturing and production details of workpiece stack-ups that have complex variable surface contours are developed. To that end, laser welding techniques are needed that would allow the laser beam to be advanced along curved or angled portions of the top surface, including multiple portions of the top surface that do not share a common plane, while simultaneously not disrupting the targeted heat input into the workpiece stack-up at various points along the beam travel pattern of the laser beam.

### SUMMARY OF THE DISCLOSURE

An embodiment of a method of laser welding a workpiece stack-up that includes at least two overlapping metal workpieces that define a welding region in which at least a portion of a top accessible surface of the workpiece stack-up is curved or angled may include several steps. In one step, a workpiece stack-up is provided that includes overlapping metal workpieces. The overlapping metal workpieces comprise at least a first metal workpiece and a second metal workpiece that overlaps with the first metal workpiece in a welding region. The first metal workpiece provides a top surface of the workpiece stack-up within the welding region and the second metal workpiece provides a bottom surface of the workpiece stack-up within the welding region. And, at least a portion of the top surface of the workpiece stack-up is curved or angled. In another step, a laser beam is directed at the top surface of the workpiece stack-up within the welding region. The laser beam has a beam spot at the top surface of the workpiece stack-up and creates a molten metal weld pool within the workpiece stack-up that intersects each faying interface established within the workpiece stack-up. In still another step, the beam spot of the laser beam is advanced along a beam travel pattern that at least partially lies on the portion of the top surface that is curved or angled to form an elongated melt pool that, upon cooling, solidifies into resolidified consolidated workpiece material to provide a laser weld joint that autogenously fusion welds the metal workpieces in the workpiece stack-up together. In yet another step, a constant focal distance of the laser beam is maintained as the laser beam is advanced along the portion of the top surface that is curved or angled while tracking the beam travel pattern.

The aforementioned embodiment of the laser welding method may be practiced on different types of workpiece stack-ups. For example, the first metal workpiece may have an exterior outer surface and a first faying surface, and the second metal workpiece may have an exterior outer surface and a second faying surface. Additionally, the exterior outer surface of the first metal workpiece may provide the top surface of the workpiece stack-up and the exterior outer surface of the second metal workpiece may provide the bottom surface of the workpiece stack-up. The first and second faying surfaces of the first and second metal workpieces, moreover, may overlap and confront to establish a faying interface.

In another example, the first metal workpiece may have an exterior outer surface and a first faying surface, and the second metal workpiece may have an exterior outer surface and a second faying surface. Additionally, the exterior outer surface of the first metal workpiece may provide the top surface of the workpiece stack-up and the exterior outer surface of the second metal workpiece may provide the bottom surface of the workpiece stack-up. The workpiece stack-up may further comprise a third metal workpiece situated between the first and second metal workpieces. The third metal workpiece may have opposed third and fourth faying surfaces. The third faying surface may overlap and confront the first faying surface of the first metal workpiece to establish a first faying interface and the fourth faying surface may overlap and confront the second faying surface of the second metal workpiece to establish a second faying interface.

The composition of the metal workpieces included in the workpiece stack-up can also vary. In one scenario, all of the metal workpieces in the workpiece stack-up are steel workpieces. Furthermore, when all of the metal workpieces are steel workpieces, at least one of the steel workpieces included in the workpiece stack-up may comprise a zinc-based surface coating. In another scenario, all of the metal workpieces in the workpiece stack-up are aluminum workpieces. And, when all of the metal workpieces are aluminum workpieces, at least one of the aluminum workpieces may comprise a refractory oxide surface coating.

The contour of the top surface of the workpiece stack-up on which the beam travel pattern lies is also subject to variation. For example, the beam travel pattern may be projected entirely onto a curved portion of the top surface. To that end, the focal distance of the laser beam is kept constant while the laser beam is advanced along the curved portion of the top surface while tracing the beam travel pattern. In another example, the beam travel pattern may be projected entirely onto an angled portion of the top surface. In that situation, the focal distance of the laser beam is kept constant while the laser beam is advanced along the angled portion of the top surface while tracing the beam travel pattern. In still another example, the beam travel pattern may be projected onto two or more portions of the top surface that lack planarity. There, the focal distance of the laser beam is kept constant while the laser beam is advanced along the two or more portions of the top surface while tracing the beam travel pattern.

Several arrangements of the two or more portions of the top surface that lack planarity are possible when the top surface is contoured in that way. In one implementation, the two or more portions that lack planarity may include a first portion and a second portion in which the first portion is planar and lies in a first extended plane and the second portion is curved and arcs away from the first portion. In that scenario, at least part of the beam travel pattern is projected onto each of the first portion and the second portion of the top surface. In another implementation, the two or more portions that lack planarity may include a first portion and a second portion in which the first portion is planar and lies in a first extended plane and the second portion is planar and lies in a second extended plane and is angled relative to the first portion. There, at least part of the beam travel pattern is projected onto each of the first portion and the second portion of the top surface. In still another implementation, the two or more portions that lack planarity may include a first portion, a second portion, and a third portion. In such circumstances, the first portion is planar and lies in a first extended plane, the second portion is curved and arcs away from the first portion, and the third portion is planar and lies in a second extended plane and further extends outwardly from the second portion. When the top surface is so configured, at least part of the beam travel pattern is projected onto each of the first portion, the second portion, and the third portion of the top surface.

The aforementioned embodiment of the laser welding method may include additional steps or may be further defined. For instance, the beam travel pattern may be selected from the group consisting of a linear weld path, a curved weld path, a periodic weld path, a circular weld path, a series of concentric circular weld paths, an elliptical weld path, a series of concentric elliptical weld paths, and a spiral weld path. Additionally, the focal distance of the laser beam may be maintained constant within a range of 0 mm to 20 mm. Moreover, a keyhole may be formed beneath the beam spot of the laser beam and may be translated through the workpiece stack-up while the laser beam is being advanced along the beam travel pattern.

An embodiment of a method of laser welding a workpiece stack-up that includes at least two overlapping metal workpieces that define a welding region in which at least a portion of a top accessible surface of the workpiece stack-up is curved may include several steps. In one step, a workpiece stack-up is provided that includes overlapping metal workpieces. The overlapping metal workpieces comprise at least a first metal workpiece and a second metal workpiece that overlaps with the first metal workpiece in a welding region. The first metal workpiece provides a top surface of the workpiece stack-up within the welding region and the second metal workpiece provides a bottom surface of the workpiece stack-up within the welding region. The top surface of the workpiece stack-up includes a curved portion. In another step, a remote laser welding apparatus is operated to advance a beam spot of the laser beam along a beam travel pattern that is projected at least partially onto the curved portion of the top surface to form an elongated melt pool in the wake of the laser beam. The elongated melt pool penetrates the workpiece stack-up from the top surface towards the bottom surface and intersects each faying interface established within the workpiece stack-up. In another step, the remote laser welding apparatus is operated to maintain a constant focal distance of the laser beam as the laser beam is advanced along the curved portion of the top surface while tracing the beam travel pattern. In yet another step, the laser beam is removed from the top surface of the workpiece stack-up to allow the elongated melt pool to fully solidify into a laser weld joint that extends from the first metal workpiece into the second metal workpiece to autogenously fusion weld the overlapping metal workpieces of the workpiece stack-up together.

The aforementioned embodiment of the laser welding method may include additional steps or may be further defined. For instance, the metal workpieces included in the workpiece stack-up may include only the first and second metal workpieces, or the metal workpieces included in the workpiece stack-up may further include a third metal workpiece situated between the first and second metal workpieces within the welding region. Additionally, the focal distance of the laser beam may be maintained constant within a range of 0 mm to 20 mm.

An embodiment of a method of laser welding a workpiece stack-up that includes at least two overlapping metal workpieces that define a welding region in which two or more portions of a top accessible surface of the workpiece stack-up lack planarity may include several steps. In one step, a workpiece stack-up is provided that includes overlapping metal workpieces. The overlapping metal workpieces comprise at least a first metal workpiece and a second metal workpiece that overlaps with the first metal workpiece in a welding region. The first metal workpiece provides a top surface of the workpiece stack-up within the welding region and the second metal workpiece provides a bottom surface of the workpiece stack-up within the welding region. Additionally, two or more portions of the top surface of the workpiece stack-up lack planarity. In another step, a beam spot of a laser beam is advanced along a beam travel pattern that is projected at least partially onto the two or more portions of the top surface that lack planarity to form an elongated melt pool in the wake of the laser beam. The elongated melt pool penetrates the workpiece stack-up from the top surface towards the bottom surface and intersects each faying interface established within the workpiece stack-up. In still another step, a constant focal distance of the laser beam is maintained as the laser beam is advanced along the two or more portions of the top surface that lack planarity while tracing the beam travel pattern. In yet another step, the laser beam is removed from the top surface of the workpiece stack-up to allow the elongated melt pool to fully solidify into a laser weld joint that extends from the first metal workpiece into the second metal workpiece to autogenously fusion weld the overlapping metal workpieces of the workpiece stack-up together.

The aforementioned embodiment of the laser welding method may include additional steps or may be further defined. For example, the two or more portions of the top surface that lack planarity may include a first portion and a second portion in which the first portion is planar and lies in a first extended plane and the second portion is curved and arcs away from the first portion. Under these circumstances, at least part of the beam travel pattern is projected onto each of the first portion and the second portion of the top surface.

### BRIEF DESCRIPTION OF THE DRAWINGS

FIG. 1 is a general illustration of a workpiece stack-up that includes two overlapping metal workpieces along with a remote laser welding apparatus that can carry out the disclosed laser welding method;

FIG. 2 is a magnified view of the laser beam depicted in FIG. 1 showing a focal point and a longitudinal axis of the laser beam and denoting a focal distance and an angle of incidence of the laser beam;

FIG. 3 is a plan view of the beam spot of the laser beam taken from the vantage of sectional lines 3-3;

FIG. 4 is a cross-sectional view of the workpiece stack-up shown in FIG. 1 while a beam spot of the laser beam is being advanced along a beam travel pattern according to one embodiment of the present disclosure to form an elongated melt pool within the workpiece stack-up that, upon cooling, solidifies into a laser weld joint comprised of resolidified consolidated workpiece material;

FIG. 5 is a cross-sectional view of the workpiece stack-up as depicted in FIG. 4 after the laser beam has been removed from the top surface and the elongated melt pool has fully solidified into the laser weld joint;

FIG. 6 is an illustration of the beam travel pattern, which is in the form of a linear stitch weld path, as projected onto the top surface of the workpiece stack-up according to one embodiment of the present disclosure;

FIG. 7 is an illustration of the beam travel pattern, which is in the form of a curved weld path, as projected onto the top surface of the workpiece stack-up according to one embodiment of the present disclosure;

FIG. 8 is an illustration of the beam travel pattern, which is in the form of a periodic weld path, as projected onto the top surface of the workpiece stack-up according to one embodiment of the present disclosure;

FIG. 9 is a cross-sectional view of the workpiece stack-up similar to the one shown in FIG. 1 in which a laser beam has been advanced along a beam travel pattern according to another embodiment of the present disclosure to form an elongated melt pool within the workpiece stack-up that has solidified into a laser weld joint comprised of resolidified consolidated workpiece material;

FIG. 10 is a cross-sectional view of the workpiece stack-up similar to the one shown in FIG. 1 in which a laser beam has been advanced along a beam travel pattern according to yet another embodiment of the present disclosure to form an elongated melt pool within the workpiece stack-up that has solidified into a laser weld joint comprised of resolidified consolidated workpiece material;

FIG. 11 is a cross-sectional view of the workpiece stack-up similar to the one shown in FIG. 1 in which a laser beam has been advanced along a beam travel pattern according to still another embodiment of the present disclosure to form an elongated melt pool within the workpiece stack-up that has solidified into a laser weld joint comprised of resolidified consolidated workpiece material;

FIG. 12 is a cross-sectional view of the workpiece stack-up similar to the one shown in FIG. 1 in which a laser beam has been advanced along a beam travel pattern according to yet another embodiment of the present disclosure to form an elongated melt pool within the workpiece stack-up that has solidified into a laser weld joint comprised of resolidified consolidated workpiece material;

FIG. 13 is a cross-sectional view of a workpiece stack-up similar to the one shown in FIG. 1 while a beam spot of the laser beam is being advanced along a beam travel pattern according to one embodiment of the present disclosure to form an elongated melt pool within the workpiece stack-up that, upon cooling, solidifies into a laser weld joint comprised of resolidified consolidated workpiece material, and wherein here the workpiece stack-up includes three metal workpieces instead of two; and

FIG. 14 is a cross-sectional view of the workpiece stack-up as depicted in FIG. 13 after the laser beam has been removed from the top surface and the elongated melt pool has fully solidified into the laser weld joint.

### DETAILED DESCRIPTION

The disclosed method of laser welding two or more stacked-up metal workpieces involves advancing a laser beam—and, in particular, the beam spot of the laser beam—along a beam travel pattern that at least partially spans a portion of an accessible top surface of the workpiece stack-up that is curved or angled. The term “angled” as used herein means the surface portion is inclined relative to another adjoining portion of the top surface. In one particular set of circumstances, the beam travel pattern may lie on two or more portions of the top surface that lack planarity; that is, the beam travel pattern as projected onto the top surface of the workpiece stack-up encroaches upon two or more portions of the top surface that do not share a common plane. When advancing the laser beam along the beam travel pattern in accordance with the disclosed laser welding method, the focal distance of the laser beam is kept constant, which in turn minimizes variations in the shape and surface area of the beam spot of the laser beam. By controlling the laser beam in this way, consequential upward and downward fluctuations of the heat input into the workpiece stack-up are avoided along the beam travel pattern. The laser weld joint formed by the laser beam in accordance with the disclosed method has a consistent shape and microstructure and, thus, possesses good strength and other mechanical properties.

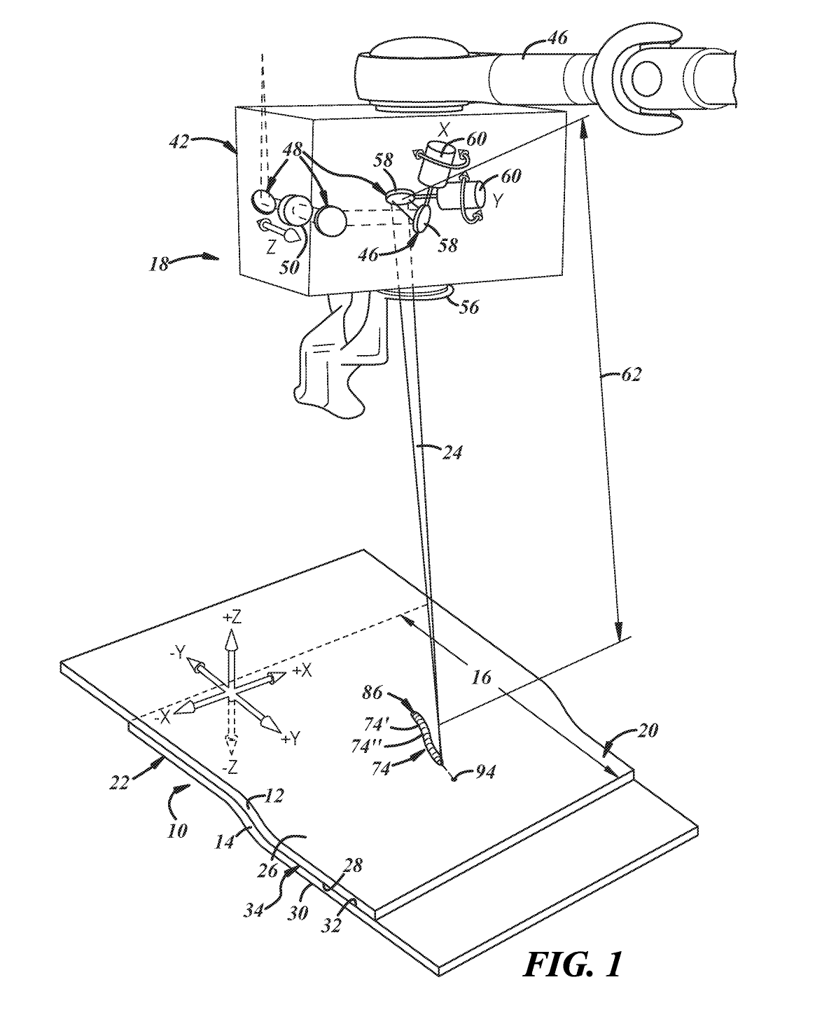

The advancement of the laser beam along the beam travel pattern on the top surface of the workpiece stack-up may be performed by a remote laser welding apparatus that includes a scanning optic laser head. The scanning optic laser head may house indexible optical components that can move the beam spot of the laser beam relative to and along the top surface of the workpiece stack-up in a wide variety of simple and complex geometric beam travel patterns while also being able to change the focal position of the laser beam if needed. The scanning optic laser head 42 shown generally in FIG. 1 and described below, as well as others that may be constructed somewhat differently, is commercially available from a variety of sources. Some notable suppliers of scanning optic laser heads for use with the remote laser welding apparatus include HIGHYAG (Kleinmachnow, Germany) and TRUMPF Inc. (Farmington, Conn., USA). Additionally, a robot arm that carries the scanning optic laser head can maneuver the laser head on multiple axes in three-dimensional space above the top surface of the workpiece stack-up.

The disclosed method of laser welding together two or more metal workpieces can be performed on a variety of workpiece stack-up configurations. For example, the disclosed method may be used in conjunction with a “2T” workpiece stack-up that includes two overlapping metal workpieces, or it may be used in conjunction with a “3T” workpiece stack-up that includes three overlapping metal workpieces. Still further, in some instances, the disclosed method may be used in conjunction with a “4T” workpiece stack-up that includes four overlapping metal workpieces. The two or more metal workpieces included in the workpiece stack-up may, for example, all be steel workpieces or they may all be aluminum workpieces, and they need not necessarily have the same composition (within the same base metal class) or have the same thickness as the others in the stack-up. The disclosed method is carried out in essentially the same way to achieve the same results regardless of whether the workpiece stack-up includes two overlapping metal workpieces or more than two overlapping metal workpieces. Any differences in workpiece stack-up configurations can be easily accommodated by adjusting the characteristics of the operating laser beam.

Referring now generally to FIG. 1, a workpiece stack-up 10 is shown in which the stack-up 10 includes at least a first metal workpiece 12 and a second metal workpiece 14 that overlap to define a welding region 16. A remote laser welding apparatus 18 that can perform the disclosed workpiece joining method is also shown. Within the confines of the welding region 16, the first and second metal workpieces 12, 14 provide a top surface 20 and a bottom surface 22, respectively, of the workpiece stack-up 10. The top surface 20 of the workpiece stack-up 10 is made available to the remote laser welding apparatus 18 and is accessible by a laser beam 24 emanating from the remote laser welding apparatus 18. And since only single side access is needed to conduct laser welding, there is no need for the bottom surface 22 of the workpiece stack-up 10 to be made accessible in the same way. The terms “top surface” and “bottom surface” as used herein are relative designations that identify the surface of the stack-up 10 (top surface) that is more proximate to and facing the remote laser welding apparatus 18 and the surface of the stack-up 10 (bottom surface) that is facing in the opposite direction.

The workpiece stack-up 10 may include only the first and second metal workpieces 12, 14, as shown in FIGS. 1-12. Under these circumstances, and as shown best in FIG. 4, the first metal workpiece 12 includes an exterior outer surface 26 and a first faying surface 28, and the second metal workpiece 14 includes an exterior outer surface 30 and a second faying surface 32. The exterior outer surface 26 of the first metal workpiece 12 provides the top surface 20 of the workpiece stack-up 10 and the exterior outer surface 30 of the second metal workpiece 14 provides the oppositely-facing bottom surface 22 of the stack-up 10. And, since the two metal workpieces 12, 14 are the only workpieces present in the workpiece stack-up 10, at least in this embodiment, the first and second faying surfaces 28, 32 of the first and second metal workpieces 12, 14 overlap and confront within the welding region 16 to establish a faying interface 34. In other embodiments, one of which is described below in connection with FIGS. 13-14, the workpiece stack-up 10 may include an additional third metal workpiece disposed between the first and second metal workpieces 12, 14 to provide the stack-up 10 with three metal workpieces within the welding region 16 instead of two.

The term “faying interface” is used broadly in the present disclosure and is intended to encompass a wide range of overlapping relationships between the confronting first and second faying surfaces 28, 32 of the first and second metal workpieces 12, 14 that can accommodate the practice of laser welding. For instance, the faying surfaces 28, 32 may establish the faying interface 34 by being in direct or indirect contact. The faying surfaces 28, 32 are in direct contact with each other when they physically abut and are not separated by a discrete intervening material layer or gaps that fall outside of normal assembly tolerance ranges. The faying surfaces 28, 32 are in indirect contact when they are separated by a discrete intervening material layer such as a sealer or adhesive—and thus do not experience the type of interfacial abutment that typifies direct contact—yet are in close enough proximity that laser welding can be practiced. As another example, the faying surfaces 28, 32 may establish the faying interface 34 by being separated by imposed gaps. Such gaps may be imposed between the faying surfaces 28, 32 by creating protruding features on one or both of the faying surfaces 28, 32 through laser scoring, mechanical dimpling, or otherwise. The protruding features maintain intermittent contact points between the faying surfaces 28, 32 that keep the surfaces 28, 32 spaced apart outside of and around the contact points by up to 1.0 mm.

Referring still to FIG. 4, the first metal workpiece 12 includes a first metal base layer 36 and the second metal workpiece 14 includes a second metal base layer 38. The first and second metal base layers 36, 38 are preferably all be composed of steel or aluminum; that is, the first and second metal base layers 36, 38 are both composed of steel or both composed of aluminum. At least one of the first or second metal base layers 36, 38, and usually both of the metal base layers 36, 38, includes a surface coating 40. The surface coating(s) 40 may be employed on one or both of the metal base layers 36, 38 for various reasons including corrosion protection, strength enhancement, and/or to improve processing, among other reasons, and the composition of the surface coating(s) 40 is based largely on the composition of the underlying metal base layers 36, 38. Taking into the account the thicknesses of the metal base layers 36, 38 and their optional surface coatings 40, each of a thickness 121 of the first metal workpiece 12 and a thickness 141 of the second metal workpiece 14 preferably ranges from 0.4 mm to 6.0 mm at least within the welding region 16. The thicknesses 121, 141 of the first and second metal workpieces 12, 14 may be the same or different from each other.

The metal base layers 36, 38 may assume any of a wide variety of metal forms and compositions that fall within the broadly-recited base metal groups of steel and aluminum. For instance, if composed of steel, each of the metal base layers 36, 38 (referred to for the moment as the first and second steel base layers 36, 38) may be separately composed of any of a wide variety of steels including a low carbon (mild) steel, interstitial-free (IF) steel, bake-hardenable steel, high-strength low-alloy (HSLA) steel, dual-phase (DP) steel, complex-phase (CP) steel, martensitic (MART) steel, transformation induced plasticity (TRIP) steel, twining induced plasticity (TWIP) steel, and boron steel such as when the workpiece(s) 12, 14 include press-hardened steel (PHS). Moreover, each of the first and second steel base layers 36, 38 may have been treated to obtain a particular set of mechanical properties, including being subjected to heat-treatment processes such as annealing, quenching, and/or tempering. The first and second steel base layers 36, 38 may be hot or cold rolled to their final thicknesses and may be pre-fabricated to have a particular profile suitable for assembly into the workpiece stack-up 10.

The surface coating 40 present on one or both of the steel base layers 36, 38 is preferably comprised of a zinc-based material or an aluminum-based material. Some examples of a zinc-based material include zinc or a zinc alloy such as a zinc-nickel alloy or a zinc-iron alloy. One particularly preferred zinc-iron alloy that may be employed has a bulk average composition that includes 8 wt % to 12 wt % iron and 0.5 wt % to 4 wt % aluminum with the balance (in wt %) being zinc. A coating of a zinc-based material may be applied by hot-dip galvanizing (hot-dip galvanized zinc coating), electrogalvanizing (electrogalvanized zinc coating), or galvannealing (galvanneal zinc-iron alloy), typically to a thickness of between 2 μm to 50 μm, although other procedures and thicknesses of the attained coating(s) may be employed. Some examples of a suitable aluminum-based material include aluminum, an aluminum-silicon alloy, an aluminum-zinc alloy, and an aluminum-magnesium alloy. A coating of an aluminum-based material may be applied by dip coating, typically to a thickness of 2 μm to 30 μm, although other coating procedures and thicknesses of the attained coating(s) may be employed. Taking into the account the thicknesses of the steel base layers 36, 38 and their optional surface coating(s) 40, the overall thickness of each of the first and second steel workpieces 12, 14 preferably ranges from 0.4 mm to 4.0 mm, or more narrowly from 0.5 mm to 2.0 mm, within the welding region 16.

If the first and second metal base layers 36, 38 are composed of aluminum, each of the metal base layers 36, 38 (referred to for the moment as the first and second aluminum base layers 36, 38) may be separately composed of unalloyed aluminum or an aluminum alloy that includes at least 85 wt % aluminum. Some notable aluminum alloys that may constitute the first and/or second aluminum base layers 36, 38 are an aluminum-magnesium alloy, an aluminum-silicon alloy, an aluminum-magnesium-silicon alloy, or an aluminum-zinc alloy. Additionally, each of the aluminum base layers 36, 38 may be separately provided in wrought or cast form. For example, each of the aluminum base layers 36, 38 may be composed of a 4xxx, 5xxx, 6xxx, or 7xxx series wrought aluminum alloy sheet layer, extrusion, forging, or other worked article, or a 4xx.x, 5xx.x, or 7xx.x series aluminum alloy casting. Some more specific kinds of aluminum alloys that can be used as the first and/or second aluminum base layers 36, 38 include AA5182 and AA5754 aluminum-magnesium alloy, AA6011 and AA6022 aluminum-magnesium-silicon alloy, AA7003 and AA7055 aluminum-zinc alloy, and Al-10Si—Mg aluminum die casting alloy. The first and/or second aluminum base layers 36, 38 may be employed in a variety of tempers including annealed (O), strain hardened (H), and solution heat treated (T).

The surface coating 40 present on one or both of the aluminum base layers 36, 38 may be a refractory oxide coating comprised of aluminum oxide compounds such as a native oxide layer that forms passively when fresh aluminum from the aluminum base layer 36, 38 is exposed to atmospheric air or some other oxygen-containing medium and/or mill scale. The surface coating 40 may also be a metallic coating comprised of zinc or tin, or it may be a metal oxide conversion coating comprised of oxides of titanium, zirconium, chromium, or silicon as disclosed in U.S. Patent Application No. US2014/0360986. A typical thickness of the surface coating 40, if present, lies anywhere from 1 nm to 10 μm depending on the composition of the coating 40 and the manner in which the coating 40 is derived, although other thicknesses may be employed. Passively formed refractory oxide coatings, for example, often have thicknesses that range from 2 nm to 10 nm when the underlying aluminum material is an aluminum alloy. Taking into account the thicknesses of the aluminum base layers 36, 38 and their optional surface coating(s) 40, the overall thickness of each of the first and second aluminum workpieces 12, 14 preferably ranges of 0.4 mm to 6.0 mm, or more narrowly from 0.5 mm to 3.0 mm, within the welding region 16.

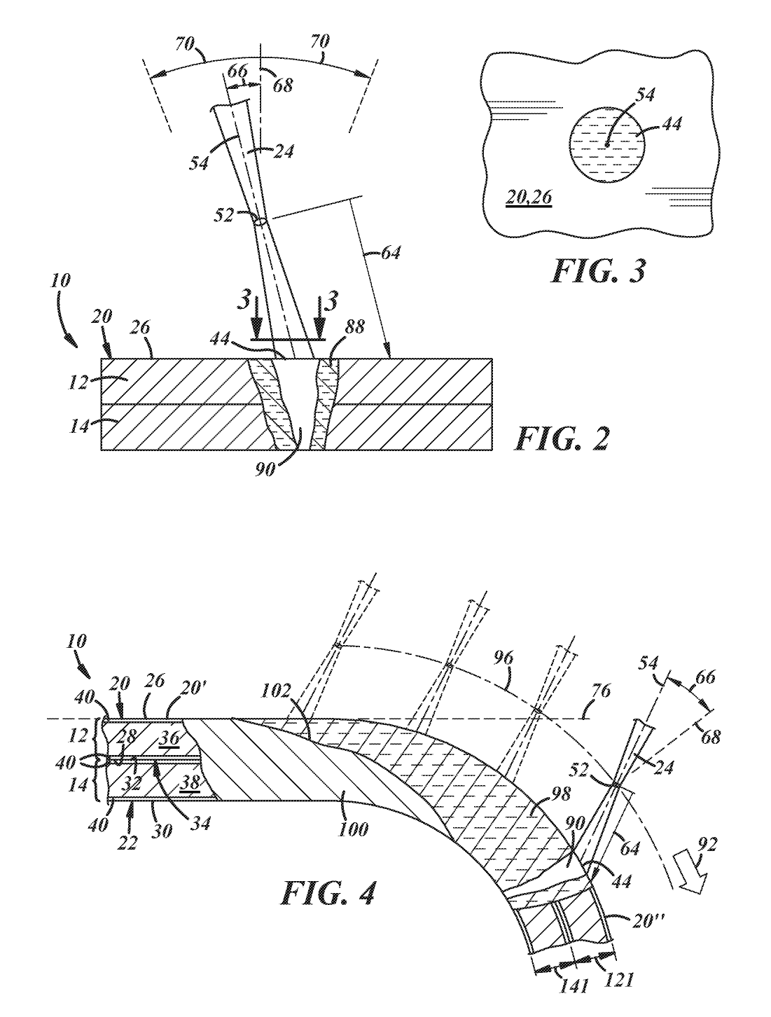

Referring back to FIG. 1, the remote laser welding apparatus 18 includes a scanning optic laser head 42. Generally speaking, the scanning optic laser head 42 directs the transmission of the laser beam 24 towards the top surface 20 of the workpiece stack-up 10 (also the exterior outer surface 26 of the first metal workpiece 12). The directed laser beam 24 has a beam spot 44, which, as shown in FIGS. 2-3, is the sectional area of the laser beam 24 at a plane oriented along the top surface 20 of the stack-up 10. The scanning optic laser head 42 is preferably mounted to a robotic arm 46 (partially shown) that can rapidly and accurately carry the laser head 42 in three-dimensional space above the top surface 20 of the stack-up 10 according to programmed instructions. The laser beam 24 used in conjunction with the scanning optic laser head 42 is preferably a solid-state laser beam operating with a wavelength in the near-infrared range (commonly considered to be 700 nm to 1400 nm) of the electromagnetic spectrum. Additionally, the laser beam 24 has a power level capability that can attain a power density sufficient to produce a keyhole, if desired, within the workpiece stack-up 10 during formation of the laser weld joint. The power density needed to produce a keyhole within the overlapping metal workpieces 12, 14 is typically between 0.5-1.5 MW/cm², depending on the compositions of the metal base layers 36, 38.

Some examples of a suitable solid-state laser beam that may be used in conjunction with the remote laser welding apparatus 18 include a fiber laser beam, a disk laser beam, and a direct diode laser beam. A preferred fiber laser beam is a diode-pumped laser beam in which the laser gain medium is an optical fiber doped with a rare earth element (e.g., erbium, ytterbium, neodymium, dysprosium, praseodymium, thulium, etc.). A preferred disk laser beam is a diode-pumped laser beam in which the gain medium is a thin laser crystal disk doped with a rare earth element (e.g., a ytterbium-doped yttrium-aluminum garnet (Yb:YAG) crystal coated with a reflective surface) and mounted to a heat sink. And a preferred direct diode laser beam is a combined laser beam (e.g., wavelength combined) derived from multiple diodes in which the gain medium is multiple semiconductors such as those based on aluminum gallium arsenide (AlGaAS) or indium gallium arsenide (InGaAS). Laser generators that can generate each of those types of lasers as well as other variations are commercially available. Other solid-state laser beams not specifically mentioned here may of course be used.

The scanning optic laser head 42 includes an arrangement of mirrors 48 that can maneuver the laser beam 24 and thus convey the beam spot 44 along the top surface 20 of the workpiece stack-up 10 within an operating envelope that at least partially encompasses the welding region 16. Here, as illustrated in FIG. 1, the position of the beam spot 44 on the top surface 20 of the workpiece stack-up 10 within the operating envelope is identified by the “x” and “y” coordinates of a three-dimensional coordinate system. In addition to the arrangement of mirrors 48, the scanning optic laser head 42 also includes a z-axis focal lens 50, which can move a focal point 52 (FIG. 2) of the laser beam 24 along a longitudinal axis 54 of the laser beam 24 to thus vary the location of the focal point 52 in a z-direction of the same three-dimensional coordinate system. Furthermore, to keep dirt and debris from adversely affecting the optical system components and the integrity of the laser beam 24, a cover slide 56 may be situated below the scanning optic laser head 42. The cover slide 56 protects the arrangement of mirrors 46 and the z-axis focal lens 50 from the surrounding environment yet allows the laser beam 24 to pass out of the scanning optic laser head 42 without substantial disruption.

The arrangement of mirrors 48 and the z-axis focal lens 50 cooperate during operation of the remote laser welding apparatus 18 to dictate the desired movement of the laser beam 24 and its beam spot 44 within the operating envelope as well as the position of the focal point 52 along the longitudinal axis 54 of the beam 24. The arrangement of mirrors 48, more specifically, includes a pair of tiltable scanning mirrors 58. Each of the tiltable scanning mirrors 58 is mounted on a galvanometer 60. The two tiltable scanning mirrors 58 can move the location of the beam spot 44—and thus change the point at which the laser beam 24 intersects the workpiece stack-up 10—relative to an x-y reference plane of the operating envelope through precise coordinated tilting movements executed by the galvanometers 60. At the same time, the z-axis focal lens 50 controls the location of the focal point 52 of the laser beam 24 in order to help administer the laser beam 24 at the correct power density. All of these optical components 50, 58 can be rapidly indexed in a matter of milliseconds or less to advance the beam spot 44 of the laser beam 24 relative to the top surface 20 of the workpiece stack-up 10 along a beam travel pattern of simple or complex geometry as projected onto the top surface 20 while controlling the location of the focal point 52.

A characteristic that differentiates remote laser welding from other conventional forms of laser welding is the focal length of the laser beam 24. Here, as shown in FIG. 1, the laser beam 24 has a focal length 62, which is measured as the distance between the focal point 52 and the last tiltable scanning mirror 58 that intercepts and reflects the laser beam 24 prior to the laser beam 24 exiting the scanning optic laser head 42. The focal length 62 of the laser beam 24 is preferably in the range of 0.4 meters to 2.0 meters with a diameter of the focal point 52 typically ranging anywhere from 100 μm to 700 μm. The focal length, as well as a focal distance 64, can be easily adjusted. The term “focal distance” as used herein refers to the distance between the focal point 52 of the laser beam 24 and the top surface 20 of the workpiece stack-up 10 along the longitudinal axis 54 of the beam 24, as shown best in FIG. 2. The focal distance 64 of the laser beam 24 is thus zero when the focal point 52 is positioned at the top surface 20 of the stack-up 10.

The term “focal position” is related to the focal distance 64 of the laser beam 24 and defines where the focal point 52 is positioned relative to the top surface of the workpiece stack-up. To be sure, when the focal point 52 of the laser beam 24 is positioned at the top surface 20 of the workpiece stack-up 10, the focal position of the laser beam 24 is zero (or “0”) and, logically, the focal distance 64 is also zero as noted above. When the focal point 52 of the laser beam 24 is located above the top surface 20 of the workpiece stack-up 10, the focal position of the laser beam 24 is the focal distance 64 reported as a positive value (+). Likewise, when the focal point 52 of the laser beam 24 is located below the top surface 20 of the workpiece stack-up, the focal position of the laser beam 24 is the focal distance 64 reported as a negative value (−). The focal position of the laser beam 24 thus gives an indication of not only the focal distance 64 but also the direction along the longitudinal axis 54 of the laser beam 24 in which the focal point 52 is displaced away from the top surface 20 of the workpiece stack-up 10. Stated differently, the absolute value of the focal position of the laser beam 24 is simply the focal distance 64.

The laser beam 24 is transmitted from the scanning optic laser head 42 and is directed at the top surface 20 of the workpiece stack-up 10 at an angle of incidence 66. As shown best in FIG. 2, the angle of incidence 66 is the angle that the longitudinal axis 54 of the beam 24 deviates from a linear direction 68 normal to the top surface 20. The angle of incidence 66 is thus 0° when the longitudinal axis 54 of the laser beam 24 is oriented perpendicular to the top surface 20 parallel to the normal linear direction 68. In other embodiments, however, the angle of incidence 66 of the laser beam 24 may deviate from normality in any direction, as represented by arrows 70 and the corresponding dashed lines, during advancement of the laser beam 24 along the beam travel pattern on the top surface 20. The realized value of the angle of incidence 66 affects the shape and surface area of the beam spot 44 of the laser beam 24. For example, with a typical Gaussian beam, the beam spot 44 of the laser beam 24 is circular when the angle of incidence 66 is 0°, and any changes in the angle of incidence 66 away from 0° causes the beam spot 44 becomes more elliptical; indeed, the eccentricity (c) of the beam spot 44, which represents how much an elliptical shape deviates from a circle, increases as the angle of incidence 66 increases in any direction relative to normality.

When the top surface 20 of the workpiece stack-up 10 includes a portion that is curved or an angled, the focal distance 64 and/or the angle of incidence 66 of the laser beam 24 changes when the laser beam 24 is advanced along that portion of the top surface 20 pursuant to conventional laser welding practices in which the focal point 64 of the laser beam 24 essentially remains in a horizontal plane as the beam spot 44 is moved relative to the top surface 20. The changes in the focal distance 64 of the laser beam 24 cause the surface area of the beam spot 44 to increase (defocusing of the laser beam 24) or decrease (focusing of the laser beam 24) compared to the other portion(s) of the beam travel pattern on that particular curved or angled surface portion. This can lead to heat input variances when the focusing and/or defocusing of the laser beam 24 causes too much melting or insufficient melting, respectively, at certain points along the beam travel pattern. The quality and structural integrity of the laser weld joint that results upon solidification of the melted workpiece material may suffer as a consequence. The effects on the surface area of the beam spot 44 that may occur when the laser beam 24 is advanced along the curved or angled portion of the top surface 20 due to changes in the angle of incidence 66 are generally considered to be negligible since any such effects on the surface area of the beam spot 44 are inconsequential compared to effects attributable to the changes in the focal distance 64 of the laser beam 24.

To address this issue of inconsistent heating through unwanted substantial deviations in the surface area of the beam spot 44, and to thereby permit laser weld joints to be consistently and repeatedly formed while advancing the laser beam 24 along a portion of the top surface 20 that is curved or angled, as well as along multiple portions of the top surface 20 that lack planarity, the optical components 50, 58 of the scanning optic laser head 42 and the robot arm 46 are controlled to keep the focal distance 64 of the laser beam 24 constant as the laser beam tracks the beam travel pattern. Whether the laser beam 24 is advanced along only a curved portion of the top surface 20, along only an angled portion of the top surface 20, or along two or more portions of the top surface that lack planarity and any of which may be curved or angled, the same general practice of keeping the focal distance 64 of the laser beam 24 constant applies. Several embodiments of this concept are described in more detail below.

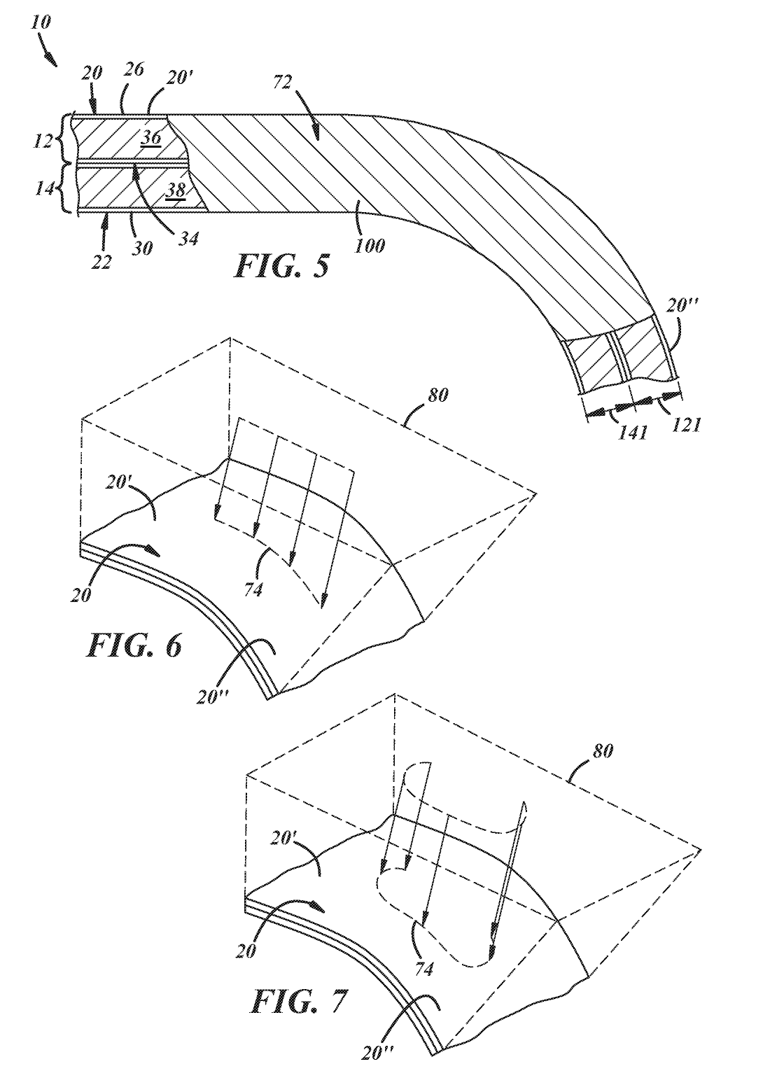

In one particular embodiment of the presently disclosed laser welding method, and referring now to FIGS. 1-5, a laser weld joint 72 (FIG. 5) is formed in the workpiece stack-up 10 by advancing the beam spot 44 of the laser beam 24 along a beam travel pattern 74 that, within the welding region, is projected onto and at least partially spans two or more portions of the top surface 20 that lack planarity. For example, and referring now to FIGS. 1 and 4, the top surface 20 as shown in this particular embodiment includes a first portion 20′ and a second portion 20″. The first portion 20′ is planar and lies in a first extended plane 76, and the second portion 20″ is curved in that it arcs away from the first portion 20′. Specifically, in this embodiment, the second portion 20″ arcs downwardly away from the first portion 20′ below the first extended plane 76. While the second portion 20″ of the top surface 20 is shown here curving away from the first portion 20′ of the top surface 20 below the first extended plane 76 of the first portion 20′, other variations of the workpiece stack-up 10 may have the second portion of the top surface 20 curving away from the first portion 20′ above the first extended plane 76. In either scenario, the disclosed laser welding method is practiced in generally the same way to achieve the same results.

The beam travel pattern 74 that is traced by the laser beam 24 may assume any of a wide variety of geometric shapes that encroach upon at least the first portion 20′ and the second portion 20″ of the top surface 20 of the workpiece stack-up 10. As shown in FIG. 1 and more specifically in FIG. 6, for example, the beam travel pattern 74 may be a linear “stitch” weld path. A linear stitch weld path is a weld path that runs directly between two points over the shortest possible distance in a 2-dimensional reference plane 80 and which is projected onto the top surface 20 of the workpiece stack-up 10. That is, the linear stitch weld path is still considered linear even though its projection onto the top surface 20 results in out-of-plane elevational changes of the weld path due to the lack of planarity of the first and the second portions 20′, 20″ of the top surface 20. The beam travel pattern 74 may be confined within the first and the second portions 20′, 20″ of the top surface 20 or it may extend through one or both of the first and the second portions 20′, 20″.

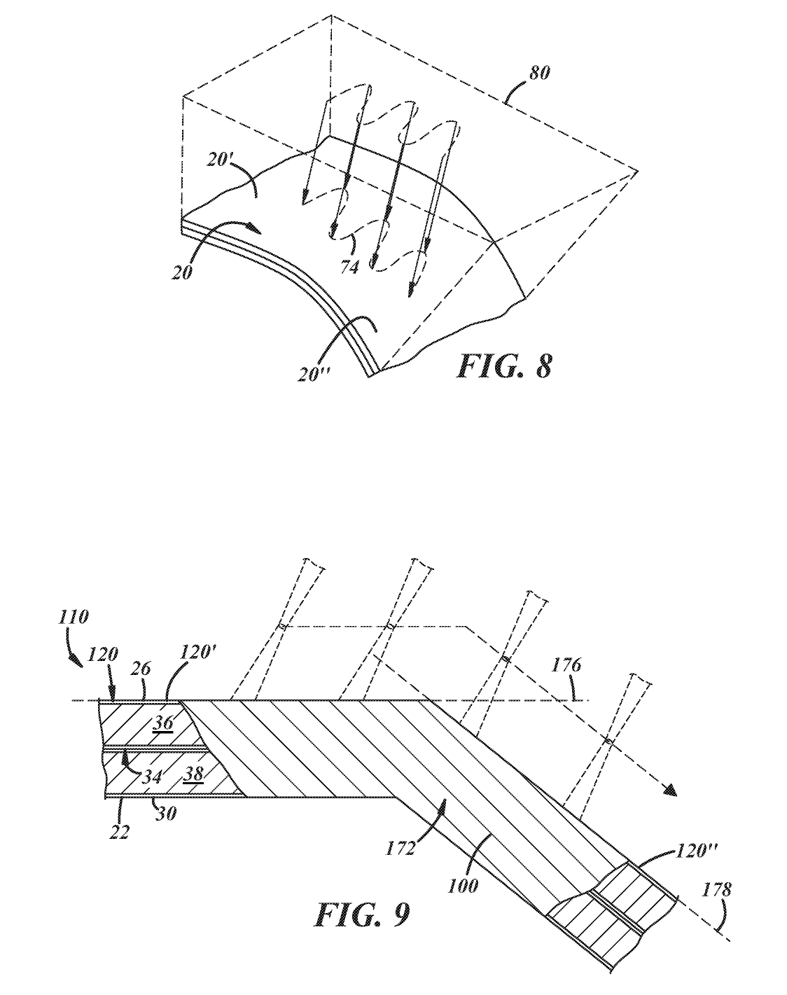

Several other alternatives geometric shapes for the beam travel pattern 74 are shown in FIGS. 7-8. For example, as shown in FIG. 7, the beam travel pattern 74 may be a curved weld path. A curved weld path is a weld path that follows an arcuate line between two points in the same 2-dimensional reference plane 80 discussed above including, for example, a “staple” or C-shaped weld path as shown, and which is projected onto the top surface 20 of the workpiece stack-up 10. In yet another example, the beam travel pattern 74 may be a periodic weld path that includes recurring wave segments that repeat themselves at regular intervals between two points in the same 2-dimensional reference plane 80 discussed above and which is projected onto the top surface 20 of the workpiece stack-up 10. Some examples of the periodic weld path include a sinusoidal waveform weld path (shown in FIG. 8), a sawtooth waveform weld path, a triangle waveform weld path, and a square waveform weld path. Still further, the beam travel pattern 74 may assume other shapes such as a circular weld path or a series of concentric circular weld paths, an elliptical weld path or a series of concentric elliptical weld paths, or a spiral weld path, to name but a few additional options.

The formation of the laser weld joint 72 begins when the laser beam 24 is directed by the scanning optic laser head 42 at the top surface 20 of the workpiece stack-up at a starting point 86 of the beam travel pattern 74. The starting point 86 may line in the first portion 20′ of the top surface 20, as shown here, but it can also lie in the second portion 20″ to the top surface 20 or even somewhere outside of the first and second portions 20′, 20″. The resultant impingement of the top surface 20 of the stack-up 10 by the laser beam 24 creates a molten metal weld pool 88 within the stack-up 10, as shown in FIG. 2. The molten metal weld pool 88 penetrates into the stack-up 10 from the top surface 20 towards the bottom surface 22 while intersecting the faying interface 34 established between the first and second metal workpieces 12, 14. Indeed, in the 2T stack-up shown here, the molten metal weld pool 88 may partially or fully penetrate the workpiece stack-up 10. A fully penetrating molten metal weld pool 88 penetrates entirely through the workpiece stack-up 10 and breaches the bottom surface 22 of the stack-up 10, as shown, while a partially penetrating molten metal weld pool 88 does not extend fully through the second metal workpiece 14 and, thus, does not breach the bottom surface 22 of the stack-up 10.

The laser beam 24, moreover, preferably has a power density sufficient to vaporize the metal workpieces 12, 14 of the workpiece stack-up 10 directly beneath the beam spot 44. This vaporizing action produces a keyhole 90, also depicted in FIG. 2, which is a column of vaporized workpiece metal that oftentimes contains plasma. The keyhole 90 is formed within and is surrounded by the molten metal weld pool 88, and is sustained against inward collapse by a recoil pressure derived from the evaporating metal that overcomes the surface tension and hydrostatic pressure of the molten metal weld pool 88. The keyhole 90 provides a conduit for the laser beam 24 to deliver energy down into the workpiece stack-up 10, thus facilitating relatively deep and narrow penetration of the molten metal weld pool 88 into the workpiece stack-up 10. In fact, like the molten metal weld pool 88, the keyhole 90 penetrates into the workpiece stack-up 10 from the top surface 20 towards the bottom surface 22 while intersecting the faying interface 34 established between the first and second metal workpieces 12, 14. The keyhole 90 may fully (as shown) or partially penetrate the workpiece stack-up 10 along with the molten metal weld pool 88. In many instances, a power density of 0.5 MW/cm² to 1.5 MW/cm² is sufficient to produce the keyhole 90.

Upon creating the molten metal weld pool 88 and preferably the keyhole 90, the laser beam 24—and, in particular, its beam spot 44—is advanced relative to the top surface 20 of the workpiece stack-up 10 along the beam travel pattern 74 in a forward welding direction 92 from the starting point 86 of the pattern 74 to an ending point 94 of the pattern 74, as illustrated in FIGS. 1 and 4. In so doing, the laser beam 24 is advanced along the first and second portions 20′, 20″ of the top surface 20 since, as discussed above, one part 74′ of the beam travel pattern 74 lies on the first portion 20′ and another part 74″ of the beam travel pattern 74 lies on the second portion 20″. To contribute to a strong and operationally acceptable laser weld joint 72 in accordance with the disclosed method, the focal distance 64 of the beam spot 44 is kept constant as the laser beam 24 is advanced along the first portion 20′ of the top surface 20 and the second portion 20″ of the top surface 20 while tracking the beam travel pattern 74. To that end, the focal distance 64 does not change when the laser beam 24 moves from the first portion 20′ to the second portion 20″ of the top surface 20, or vice versa, by more than variances of ±0.3 mm for the focal distance 64 or, more narrowly, by more than variances of ±0.1. The broken line identified by reference numeral 96 in FIG. 4 illustrates the flight of the focal point 52 as the laser beam 24 is advanced along the portions 20′, 20″ of the top surface 20 with a constant focal distance 64.

By keeping the focal distance 64 of the laser beam 24 constant as the laser beam traces the beam travel pattern 74 over the first and second portions 20′, 20″ of the top surface 20, corresponding deviations in the surface area of the beam spot 44 is minimized. A steady constant surface area of the beam spot 44 can help avoid consequential upward and downward fluctuations of the heat input into the workpiece stack-up 10 at various points along the beam travel pattern 74 from what is expected for a given power level and travel speed of the laser beam 24. The focal distance 64 is kept constant through coordinated control of the optical components 50, 58 of the scanning optic laser head 42 and, if necessary, the movement of the scanning optic laser head 42 in the space above the top surface 20 of the workpiece stack-up 10 by way of the robot arm 46. The operation and control of the scanning optic laser head 42 and its movement can be programmed into the accompanying control equipment including the scanner, laser, and robot controllers.

The specific value(s) of the focal distance 64 of the laser beam 24 that are sustained during advancement of the laser beam 24 along the beam travel pattern 74 falls within a certain workable range. In certain instances, for example, the focal distance 64 may lie between 0 mm and 20 mm above or below the top surface 20, which corresponds to a focal position range of −20 mm to +20 mm, and the angle of incidence 66 may lie between 0° and 45° with the deviations from normality up to 45° being either forward (pulling beam arrangement) or rearward (pushing beam arrangement) from the normal linear direction 68 in relation to the forward welding direction 92. Preferably, though, the focal distance lies between 0 mm and 10 mm above the top surface 20, which corresponds to a focal position range of 0 mm to +10 mm, and the angle of incidence lies between 0° and 30° with deviations from normality being either forward or rearward from the normal linear direction 68. In terms of the other characteristics of the laser beam 24 that affect the welding process, the laser beam 24 may have a power level that ranges from 1.0 kW to 10 kW, or more narrowly from 2.0 kW to 6.0 kW, while being advanced along the beam travel pattern 74 at a travel speed that ranges from 1.0 m/min to 100 m/min, or more narrowly from 3.0 m/min to 50 m/min.

The advancement of the laser beam 24 along the beam travel pattern 74—during which time the focal distance 64 is kept constant—translates the molten weld pool 88 and, if present, the keyhole 90, through the workpiece stack-up 10 along a route that mimics the beam travel pattern 74. This causes the molten weld pool 88 to elongate in the wake of the forward movement of the laser beam 24 to form an elongated melt pool 98 that contains penetrating molten workpiece material. The elongated melt pool 98 penetrates far enough into or through the workpiece stack-up 10 so that it intersects the faying interface 34 established between the first and second metal workpieces 12, 14. In FIG. 4, for instance, the elongated melt pool 98 is shown as fully penetrating through the workpiece stack-up 10. In other embodiments, however, the elongated melt pool 98 may partially penetrate the workpiece stack-up 10 but still intersect the faying interface 34, which, consequently, means the pool 98 fully traverses the thickness 121 of the first metal workpiece 12 but only partially traverses the thickness 141 of the second metal workpiece 14. As the laser beam 24 continues to advance along the beam travel pattern 74, the elongated melt pool 98 begins to cool and solidify into consolidated resolidified workpiece material 100 in the same direction as the forward movement of the laser beam 24. A solidification front 102 that represents the progress of such solidification within the elongated melt pool 98 is shown generally in FIG. 4.

Once the beam spot 44 of the laser beam 24 has finished tracing the beam travel pattern 74, the laser beam 24 is removed from the top surface 20 of the workpiece stack-up 10 at the location of the beam travel pattern 74. This can be done by halting transmission of the laser beam 24 to the workpiece stack-up 10 or simply relocating the laser beam 24 to another region of the top surface 20 outside of the weld location. The resultant cessation of energy and heat transfer allows the elongated melt pool 98 to completely solidify into consolidated resolidified workpiece material 100, as shown in FIG. 5. The consolidated resolidified workpiece material 100 obtained from the laser beam 24 constitutes the laser weld joint 72. The laser weld joint 72 extends either fully through or partially into the workpiece stack-up 10 depending on the penetration depth of the preceding elongated melt pool 98. That is, the laser weld joint 72 extends from the first metal workpiece 12 into the second metal workpiece 14—or more specifically from the top surface 20 of the stack-up 10 towards the bottom surface 22 while intersecting the faying interface 34—so as to autogenously fusion weld the metal workpieces 12, 14 together. The consolidated resolidified workpiece material 100 has a consistent shape and microstructure that is attributable at least in part to the controlled advancement of the laser beam 24 along the beam travel pattern 74.

In the example embodiment described above, the top surface 20 of the workpiece stack-up 10 includes a planar first portion 20′ and a curved second portion 20″, and the beam travel pattern 74 encroaches upon each of those portions 20′, 20″ of the top surface 20. The presently disclosed laser welding method is not limited only to that particular surface configuration. For instance, as shown in FIG. 9, a top surface 120 of another version of the workpiece stack-up, which is identified by reference numeral 110, may include a first portion 120′ that is planar and lies in a first extended plane 176, much like in the previous embodiment, and a second portion 120″ that is also planar and lies in a second extended plane 178. The second portion 120″ of the top surface 120 is angled downwardly away from the first portion 120′ of the top surface 120, as shown, but could alternatively be angled upwardly away from the first portion 120′. In this embodiment, a laser weld joint 172 is formed in the same way as previously described with the only difference being that the laser beam 24 is advanced along two planar portions 120′, 120″ of the top surface 120 while tracing the beam travel pattern 74 instead of a planar portion 20′ and a curved portion 20″. Here, in FIG. 9, the prior advancement of the laser beam 24 that resulted in the formation of the laser weld joint 172 is shown in phantom with the understanding that the discussion above in connection with FIGS. 1-8 regarding the advancement of the laser beam 24 and the formation of the weld joint is equally applicable here.

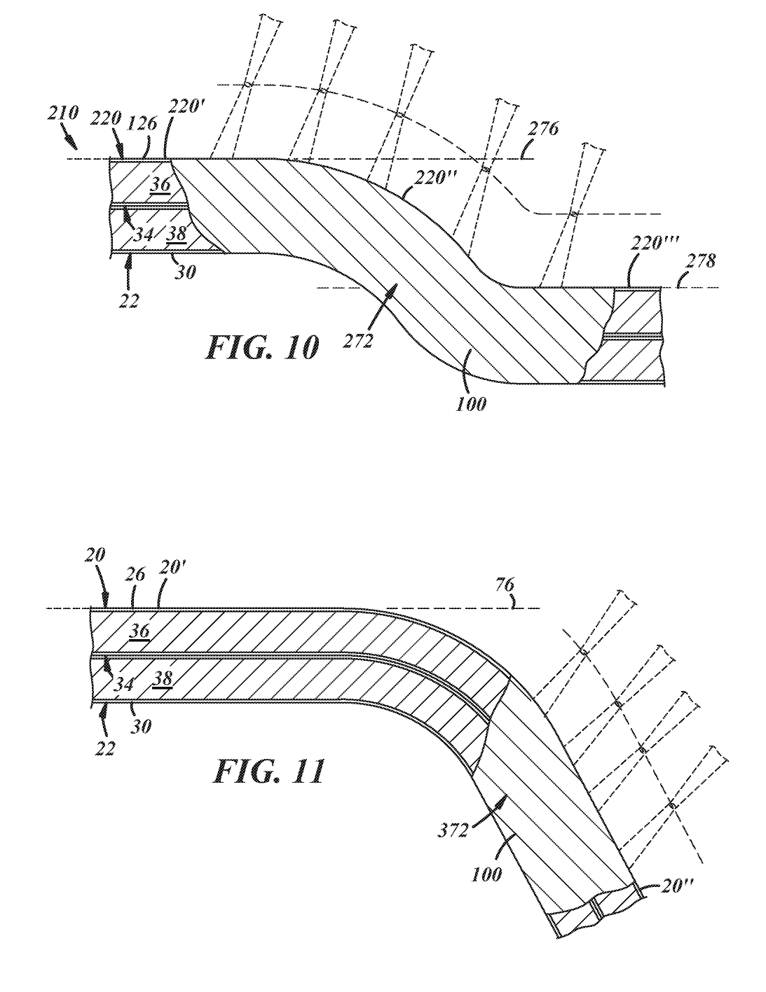

In another example, as shown in FIG. 10, a top surface 220 of still another version of the workpiece stack-up, which is identified by reference numeral 210, may include a first portion 220′ that is planar and lies in a first extended plane 276, a second portion 220″ that is curved and arcs downwardly away from the first portion 220′ below the first extended plane 276, and a third portion 220′″ that is planar and lies in a second extended plane 278 and which extends outwardly from the second portion 220″. Of course, in an alternative implementation, the second portion 220″ may arc upwardly away from the first portion 220′ to the third portion 220′″ despite not being specifically shown here. Again, in this embodiment, a laser weld joint 272 is formed in the same way as previously described with the only difference being that the laser beam 24 is advanced along two planar portions 220′, 220′″ and a curved portion 220″ of the top surface 220 while tracing the beam travel pattern 74 instead of a planar portion 20′ and a curved portion 20″. Here, in FIG. 10, the prior advancement of the laser beam 24 that resulted in the formation of the laser weld joint 272 is shown in phantom with the understanding that the discussion above in connection with FIGS. 1-8 regarding the advancement of the laser beam 24 and the formation of the weld joint is equally applicable here.

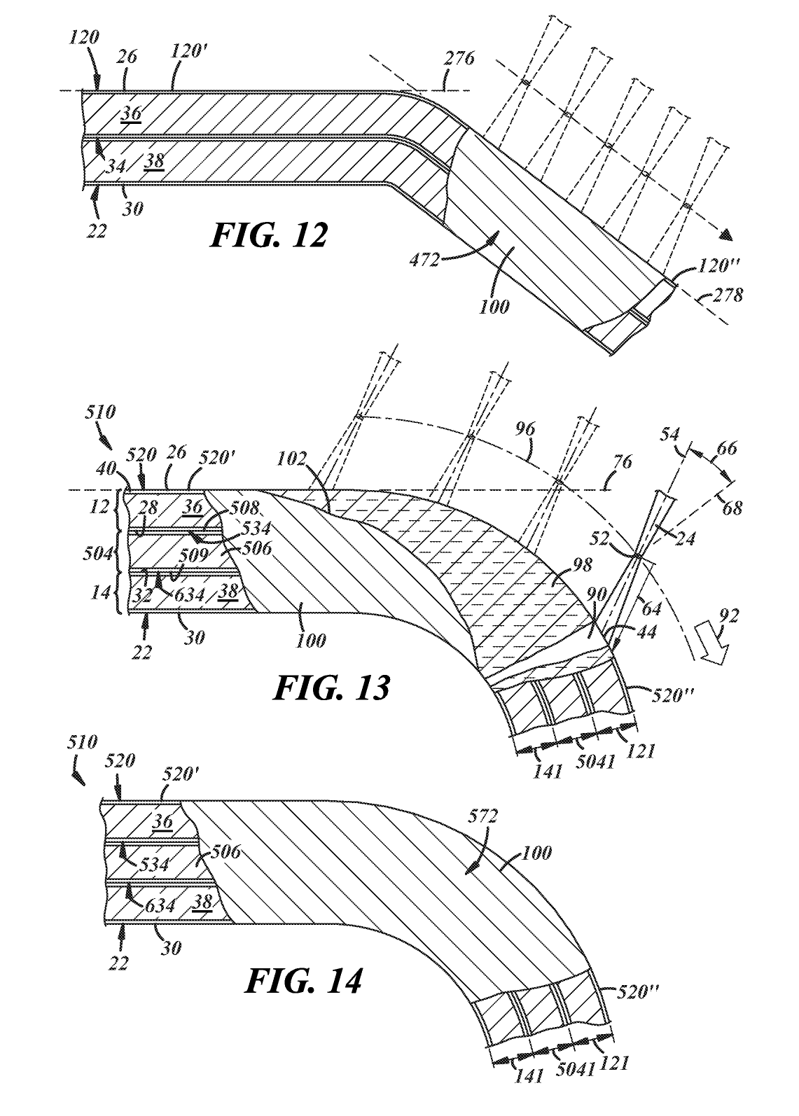

The embodiments discussed above with regards to FIGS. 1-10 are directed to situations in which the beam travel pattern 74 is spread at least partially across two or more portions of the top surface 20, 120, 220 of the workpiece stack-up 10, 110, 210 that lack planarity. In other applications of the disclosed laser welding method, however, the beam travel pattern 74 may lie only on a portion of the top surface that is curved or only on a portion of the top surface that is angled. For example, as depicted in FIG. 11, which is related to FIGS. 1 and 4, the beam travel pattern 74 may lie only on the second portion 20″ of the top surface 20, which means that the laser beam 24 is advanced along the curved top surface portion 20″ only when tracing the beam travel pattern 74 during formation of a laser weld joint 372. In another example, as depicted in FIG. 12, which is related to FIGS. 1 and 4, the beam travel pattern 74 may lie only on the second portion 120″ of the top surface 120, which means that the laser beam 24 is advanced along the angled top surface portion 120″ only when tracing the beam travel pattern 74 during formation of a laser weld joint 472. In each of the embodiments just discussed, the prior advancement of the laser beam 24 that resulted in the formation of the laser weld joint 372, 472 is shown in phantom with the understanding that the discussion above in connection with FIGS. 11-12 regarding the advancement of the laser beam 24 and the formation of the weld joint is equally applicable here.

FIGS. 1-12 have been described in the context of an embodiment of the workpiece stack-up 10 that includes two overlapping metal workpieces 12, 14 establishing a single faying interface 34. Of course, as shown in FIGS. 13-14, the disclosed laser welding method may also be practiced on a workpiece stack-up 510 that includes an additional third metal workpiece 504, with a thickness 5041, situated between the first and second metal workpieces 12, 14. The third metal workpiece 504, if present, includes a third metal base layer 506 that may also be coated with a surface coating 40 (as shown). The third metal workpiece 504 is similar in many general respects to the first and second metal workpieces 12, 14 and, accordingly, the description of the first and second metal workpieces 12, 14 set forth above (in particular the composition of the metal base layers, their possible surface oxide coatings, and the workpiece thicknesses) applies fully to the third metal workpiece 504. The welding region 16 in this embodiment of the workpiece stack-up 510 is now defined by the extent of the common overlap of all of the first, second, and metal workpieces 12, 14, 504.

As a result of stacking the first, second, and third metal workpieces 12, 14, 504 in overlapping fashion to provide the workpiece stack-up 510, and as shown best in FIG. 13, the third metal workpiece 504 has two faying surfaces: a third faying surface 508 and a fourth faying surface 509. The third faying surface 508 overlaps and confronts the first faying surface 28 of the first metal workpiece 12 and the fourth faying surface 509 overlaps and confronts the second faying surface 32 of the second metal workpiece 14. Within the welding region 16, the confronting first and third faying surfaces 28, 508 of the first and third metal workpieces 12, 504 establish a first faying interface 534 and the confronting second and fourth faying surfaces 32, 509 of the second and third metal workpieces 14, 504 establish a second faying interface 634. These faying interfaces 534, 634 are the same type and encompass the same attributes as the faying interface 34 described above with respect to the 2T stack-up embodiment shown in FIGS. 1-12. Consequently, in this embodiment, the exterior outer surfaces 26, 30 of the flanking first and second metal workpieces 12, 14 still face away from each other in opposite directions and constitute the top and bottom surfaces 20, 22 of the workpiece stack-up 310.

The top surface of the workpiece stack-up 510, which is identified by reference numeral 520, includes two or more portions that lack planarity. In the embodiment depicted here, the top surface 520 includes a first planar portion 520′ and a second curved portion 520″ that share the same relation and relative arrangement as described earlier with regards to the embodiment shown in FIGS. 1 and 4. The relevant discussion of the first and second portions 20′, 20″ is thus equally applicable here with the only exception being that three overlapping metal workpieces 12, 504, 14 are present instead of two overlapping metal workpieces 12, 14. Of course, in other embodiments, the top surface 520 of the workpiece stack-up 510 may resemble that of workpiece stack-ups 110, 210 shown in FIGS. 9-12 or any other arrangement of surface portions that lack planarity. The disclosed laser welding method may be practiced on the “3T” workpiece stack-up 510 to form a laser weld joint 572 in the same general way as described above for the “2T” workpiece stack-ups 10, 110, 210.

Specifically, to form the laser weld joint 572, the laser beam 24 may be advanced along the beam travel pattern that, within the welding region 16, is projected onto and at least partially spans the first and second portions 520′, 520″ of the top surface 520, or only a curved or angled portion of the top surface 520 similar to the previous embodiments, while keeping the focal distance 64 constant. The advancement of the laser beam 24 along the beam travel pattern 74 translates the molten weld pool 88 and, if present, the keyhole 90, through the workpiece stack-up 510 along a route that mimics the beam travel pattern 74. The resultant elongated melt pool 98 penetrates far enough into or through the workpiece stack-up 510 (either fully as shown or partially) that it intersects each of the faying interfaces 534, 534 established between the first, third, and second metal workpieces 12, 504, 14, as shown in FIG. 13. As the laser beam 24 continues to advance along the beam travel pattern 74, the elongated melt pool 98 begins to cool and solidify into consolidated resolidified workpiece material 100 in the same direction as the forward movement of the laser beam 24. Once the beam spot 44 of the laser beam 24 has finished tracing the beam travel pattern 74, the laser beam 24 is removed from the top surface 520 of the workpiece stack-up 510 at the location of the beam travel pattern 74, and elongated melt pool 98 solidifies completely into consolidated resolidified workpiece material 100, as shown in FIG. 14, to obtain the laser weld joint 572.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A method of laser welding a workpiece stack-up that includes at least two overlapping metal workpieces that define a welding region in which at least a portion of a top accessible surface of the workpiece stack-up is curved or angled, the method comprising:
providing a workpiece stack-up that includes overlapping metal workpieces, the overlapping metal workpieces comprising at least a first metal workpiece and a second metal workpiece that overlaps with the first metal workpiece in a welding region, the first metal workpiece providing a top surface of the workpiece stack-up within the welding region and the second metal workpiece providing a bottom surface of the workpiece stack-up within the welding region, wherein at least a portion of the top surface is curved or angled;
directing a laser beam at the top surface of the workpiece stack-up within the welding region, the laser beam having a beam spot at the top surface of the workpiece stack-up and creating a molten metal weld pool within the workpiece stack-up that intersects each faying interface established within the workpiece stack-up;
advancing the beam spot of the laser beam along a beam travel pattern that at least partially lies on the portion of the top surface that is curved or angled to form an elongated melt pool that, upon cooling, solidifies into resolidified consolidated workpiece material to provide a laser weld joint that autogenously fusion welds the metal workpieces in the workpiece stack-up together; and
maintaining a constant focal distance of the laser beam as the laser beam is advanced along the portion of the top surface that is curved or angled while tracking the beam travel pattern.

2. The method set forth in claim 1, wherein the first metal workpiece has an exterior outer surface and a first faying surface, and the second metal workpiece has an exterior outer surface and a second faying surface, the exterior outer surface of the first metal workpiece providing the top surface of the workpiece stack-up and the exterior outer surface of the second metal workpiece providing the bottom surface of the workpiece stack-up, and wherein the first and second faying surfaces of the first and second metal workpieces overlap and confront to establish a faying interface

3. The method set forth in claim 1, wherein the first metal workpiece has an exterior outer surface and a first faying surface, and the second metal workpiece has an exterior outer surface and a second faying surface, the exterior outer surface of the first metal workpiece providing the top surface of the workpiece stack-up and the exterior outer surface of the second metal workpiece providing the bottom surface of the workpiece stack-up, and wherein the workpiece stack-up comprises a third metal workpiece situated between the first and second metal workpieces, the third metal workpiece having opposed third and fourth faying surfaces, the third faying surface overlapping and confronting the first faying surface of the first metal workpiece to establish a first faying interface and the fourth faying surface overlapping and confronting the second faying surface of the second metal workpiece to establish a second faying interface.

4. The method set forth in claim 1, wherein the beam travel pattern is projected entirely onto a curved portion of the top surface, and wherein the focal distance of the laser beam is kept constant while the laser beam is advanced along the curved portion of the top surface while tracing the beam travel pattern.

5. The method set forth in claim 1, wherein the beam travel pattern is projected entirely onto an angled portion of the top surface, and wherein the focal distance of the laser beam is kept constant while the laser beam is advanced along the angled portion of the top surface while tracing the beam travel pattern.

6. The method set forth in claim 1, wherein the beam travel pattern is projected onto two or more portions of the top surface that lack planarity, and wherein the focal distance of the laser beam is kept constant while the laser beam is advanced along the two or more portions of the top surface while tracing the beam travel pattern.

7. The method set forth in claim 6, wherein the two or more portions that lack planarity include a first portion and a second portion, wherein the first portion is planar and lies in a first extended plane, wherein the second portion is curved and arcs away from the first portion, and wherein at least part of the beam travel pattern is projected onto each of the first portion and the second portion of the top surface.

8. The method set forth in claim 6, wherein the two or more portions that lack planarity include a first portion and a second portion, wherein the first portion is planar and lies in a first extended plane, wherein the second portion is planar and lies in a second extended plane and is angled relative to the first portion, and wherein at least part of the beam travel pattern is projected onto each of the first portion and the second portion of the top surface.

9. The method set forth in claim 6, wherein the two or more portions that lack planarity include a first portion, a second portion, and a third portion, wherein the first portion is planar and lies in a first extended plane, wherein the second portion is curved and arcs away from the first portion, wherein the third portion is planar and lies in a second extended plane and further extends outwardly from the second portion, and wherein at least part of the beam travel pattern is projected onto each of the first portion, the second portion, and the third portion of the top surface.

10. The method set forth in claim 1, wherein all of the metal workpieces in the workpiece stack-up are steel workpieces or all of the metal workpieces in the workpiece stack-up are aluminum workpieces.

11. The method set forth in claim 10, wherein all of the metal workpieces in the workpiece stack-up are steel workpieces, and wherein at least one of the steel workpieces comprises a zinc-based surface coating.

12. The method set forth in claim 10, wherein all of the metal workpieces in the workpiece stack-up are aluminum workpieces, and wherein at least one of the aluminum workpieces comprises a refractory oxide surface coating.

13. The method set forth in claim 1, wherein the beam travel pattern is selected from the group consisting of a linear weld path, a curved weld path, a periodic weld path, a circular weld path, a series of concentric circular weld paths, an elliptical weld path, a series of concentric elliptical weld paths, and a spiral weld path.

14. The method set forth in claim 1, wherein the focal distance is maintained constant within a range of 0 mm to 20 mm.

15. The method set forth in claim 1, wherein a keyhole is formed beneath the beam spot of the laser beam and is translated through the workpiece stack-up while the laser beam is being advanced along the beam travel pattern.

16. A method of laser welding a workpiece stack-up that includes at least two overlapping metal workpieces that define a welding region in which at least a portion of a top accessible surface of the workpiece stack-up is curved, the method comprising:
providing a workpiece stack-up that includes overlapping metal workpieces, the overlapping metal workpieces comprising at least a first metal workpiece and a second metal workpiece that overlaps with the first metal workpiece in a welding region, the first metal workpiece providing a top surface of the workpiece stack-up within the welding region and the second metal workpiece providing a bottom surface of the workpiece stack-up within the welding region, wherein the top surface of the workpiece stack-up includes a curved portion;
operating a remote laser welding apparatus to advance a beam spot of the laser beam along a beam travel pattern that is projected at least partially onto the curved portion of the top surface to form an elongated melt pool in the wake of the laser beam, the elongated melt pool penetrating the workpiece stack-up from the top surface towards the bottom surface and intersecting each faying interface established within the workpiece stack-up;
operating the remote laser welding apparatus to maintain a constant focal distance of the laser beam as the laser beam is advanced along the curved portion of the top surface while tracing the beam travel pattern; and
removing the laser beam from the top surface of the workpiece stack-up to allow the elongated melt pool to fully solidify into a laser weld joint that extends from the first metal workpiece into the second metal workpiece to autogenously fusion weld the overlapping metal workpieces of the workpiece stack-up together.

17. The method set forth in claim 16, wherein the metal workpieces included in the workpiece stack-up include only the first and second metal workpieces, or wherein the metal workpieces included in the workpiece stack-up further include a third metal workpiece situated between the first and second metal workpieces within the welding region.

18. The method set forth in claim 15, wherein the focal distance is maintained constant within a range of 0 mm to 20 mm.

19. A method of laser welding a workpiece stack-up that includes at least two overlapping metal workpieces that define a welding region in which two or more portions of a top accessible surface of the workpiece stack-up lack planarity, the method comprising:
providing a workpiece stack-up that includes overlapping metal workpieces, the overlapping metal workpieces comprising at least a first metal workpiece and a second metal workpiece that overlaps with the first metal workpiece in a welding region, the first metal workpiece providing a top surface of the workpiece stack-up within the welding region and the second metal workpiece providing a bottom surface of the workpiece stack-up within the welding region, wherein two or more portions of the top surface of the workpiece stack-up lack planarity;
advancing a beam spot of a laser beam along a beam travel pattern that is projected at least partially onto the two or more portions of the top surface that lack planarity to form an elongated melt pool in the wake of the laser beam, the elongated melt pool penetrating the workpiece stack-up from the top surface towards the bottom surface and intersecting each faying interface established within the workpiece stack-up;
maintaining a constant focal distance of the laser beam as the laser beam is advanced along the two or more portions of the top surface that lack planarity while tracing the beam travel pattern; and
removing the laser beam from the top surface of the workpiece stack-up to allow the elongated melt pool to fully solidify into a laser weld joint that extends from the first metal workpiece into the second metal workpiece to autogenously fusion weld the overlapping metal workpieces of the workpiece stack-up together.

20. The method set forth in claim 19, wherein the two or more portions of the top surface that lack planarity include a first portion and a second portion, wherein the first portion is planar and lies in a first extended plane, wherein the second portion is curved and arcs away from the first portion, and wherein at least part of the beam travel pattern is projected onto each of the first portion and the second portion of the top surface.
